(19) United States
(12) Patent Application Publication
(10) Pub. No.: US 2014/0002339 A1
(43) Pub. Date: Jan. 2, 2014

(54) Surface With Touch Sensors for Detecting Proximity

(71) Applicant: David Brent Guard, Southampton (GB)

(72) Inventor: David Brent Guard, Southampton (GB)

(21) Appl. No.: 13/536,615

(22) Filed: Jun. 28, 2012

(51) Int. Cl. G09G 5/00

(52) U.S. Cl. 345/156

(57) ABSTRACT

In one embodiment, a method includes displaying a first image on a display. The method further includes correlating at least a portion of the first image to at least a portion of a surface. The surface includes one or more sensors operable to detect a proximity of one or more fingers of a user to the surface. The method further includes detecting the proximity of the one or more fingers of the user to the surface. The proximity of the one or more fingers being detected without the one or more fingers touching the surface. The method further includes displaying a second image representative of the one or more fingers on the display in correlation with the at least a portion of the first image.

### TECHNICAL FIELD

This disclosure generally relates to touch sensors.

### BACKGROUND

A touch sensor may detect the presence and location of a touch or the proximity of an object (such as a user's finger or a stylus) within a touch-sensitive area of the touch sensor overlaid on a display screen, for example. In a touch-sensitive-display application, the touch sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A touch-sensor controller may process the change in capacitance to determine its position on the touch screen.

### BRIEF DESCRIPTION OF THE DRAWINGS

FIG. 1 illustrates an example touch sensor with an example touch-sensor controller.

FIG. 2 illustrates an example system that detects a proximity of one or more fingers of a user, and displays an image representative of the one or more fingers on a display.

FIGS. 3A-3C illustrate example images displayed on a user device.

FIG. 4 illustrates an example method for detecting a proximity of one or more fingers of a user to a surface, and displaying an image representative of the one or more fingers on a display.

### DESCRIPTION OF EXAMPLE EMBODIMENTS

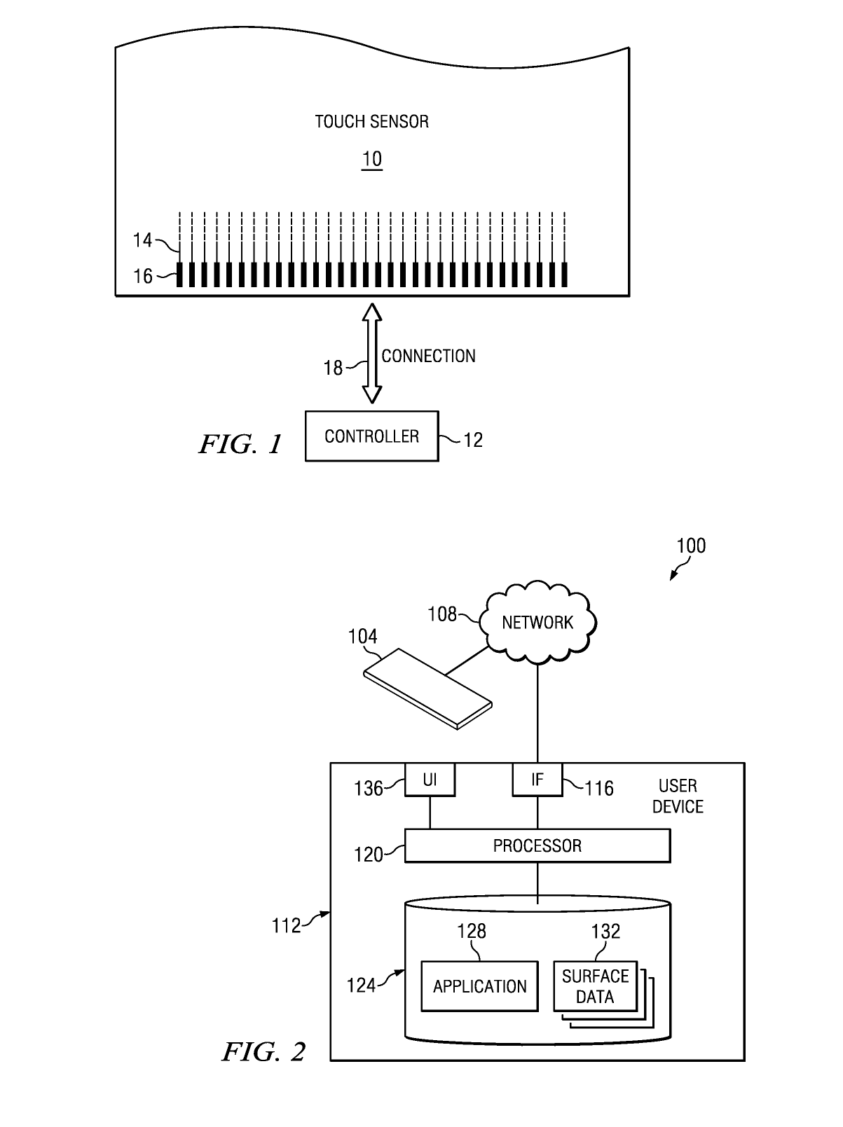

FIG. 1 illustrates an example touch sensor 10 with an example touch-sensor controller 12. Touch sensor 10 and touch-sensor controller 12 may detect the presence and location of a touch or the proximity of an object within a touch-sensitive area of touch sensor 10. Herein, reference to a touch sensor may encompass both the touch sensor and its touch-sensor controller, where appropriate. Similarly, reference to a touch-sensor controller may encompass both the touch-sensor controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a ground electrode, a guard electrode, a drive electrode, or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), where appropriate. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material, and the fine lines of conductive material may occupy approximately 5% of the area of its shape in a hatched, mesh, or other suitable pattern. Herein, reference to FLM encompasses such material, where appropriate. Although this disclosure describes or illustrates particular electrodes made of particular conductive material forming particular shapes with particular fill percentages having particular patterns, this disclosure contemplates any suitable electrodes made of any suitable conductive material forming any suitable shapes with any suitable fill percentages having any suitable patterns.

Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes). As an alternative, where appropriate, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. By measuring changes in capacitance throughout the array, touch-sensor controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Touch-sensor controller 12 may detect and process the change in capacitance to determine the presence and location of the touch or proximity input. Touch-sensor controller 12 may then communicate information about the touch or proximity input to one or more other components (such one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, where appropriate. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

FIG. 2 illustrates an example system 100 that detects a proximity of one or more fingers of a user, and displays an image representative of the one or more fingers on a display. According to the illustrated embodiment, system 100 includes surface 104, network 108, and user device 112. As is discussed in detail below, surface 104 detects a proximity of one or more fingers of a user to the surface 104, and user device 112 displays an image representative of the one or more fingers on a user interface 136. In particular embodiments, by detecting the proximity of one or more fingers and displaying an image representative of the one or more fingers, system 100 may provide a user with the intuitive nature of a touch screen without requiring a user to touch a display screen. As such, the display screen of the user device 112 may not be obscured by a user's hands, the display screen of the user device 112 may remain cleaner (e.g., since a user does not need to touch the display), and/or the user may not need to type on the display screen of user device 112, thereby providing for a more comfortable typing environment. Furthermore, in particular embodiments, system 100 may provide a user with an easily configurable keyboard that is not language specific. Additionally, in particular embodiments, because the touch sensors are included on or in the surface 104 (as opposed to the display screen), the touch sensors need not be optically clear sensors.

Surface 104 represents any surface that includes one or more sensors that may detect proximity. As an example and not by way of limitation, surface 104 may be an interactive pad, a mat (such as a flat mat, a formed mat, a portable mat, and/or a mat that rolls up), a keyboard, and/or any other device or surface that includes one or more sensors for detecting a proximity. Surface 104 may be made of any suitable material. As an example and not by way of limitation, surface 104 may be made of a material having a dielectric constant of 3 or above, such as a polycarbonate, PET, acrylic, and/or tactile polymer. As another example and not by way of limitation, surface 104 may be made of any material that allows a touch sensor (such as touch sensor 10 of FIG. 1) to detect a proximity.

Surface 104 may have one or more touch sensors on or in surface 104 for detecting a proximity. Touch sensors may be positioned on or in surface 104 in any suitable manner. As an example and not by way of limitation, when surface 104 includes a keyboard, one or more touch sensors may be molded into the shape of one or more keys of the keyboard using in-mold lamination. In such an example, the touch sensor may be vacuum formed into the shape of a key, and liquid plastic resin may be injected onto the touch sensor by an injection molding system to form the final shape of the key of the keyboard.

Surface 104 may detect a proximity of an object (such as one or more fingers of a user) to the surface 104. As an example and not by way of limitation, when a user places his hand (or any other suitable object) near surface 104, the touch sensors of surface 104 may detect the proximity of the user's hand (or any other suitable object). In such an example, when the user's hand moves to the upper left portion of surface 104, the touch sensors of surface 104 may detect the movement of the user's hand to the top left portion of surface 104 and may further detect the location of the user's hand in the top left portion of surface 104. As another example and not by way of limitation, when a user moves one or more of his fingers near a particular key of surface 104 (such as when surface 104 is a keyboard having one or more keys), surface 104 may detect the movement of the user's fingers towards the key and the location of the user's fingers near the key of surface 104. In particular embodiments, surface 104 may detect a proximity (or change in proximity) without the user having to actually touch surface 104.

Surface 104 may also detect one or more gestures made by a user within a proximity of surface 104. A gesture may refer to any suitable action performed by a user. Examples of gestures may include a scrolling gesture (e.g., when a user moves his finger in a particular direction), a zooming gesture (e.g., when the user makes a pinching motion with two fingers to zoom out or an expanding motion with two fingers to zoom in), a turning gesture (e.g., when the user imitates like they are turning a volume knob of a device), a wake up gesture (e.g., when the user passes his hands over the surface 104 in order to wake up the user device 112), any other gestures, or any combination of the preceding. Surface 104 may detect a gesture at all portions of surface 104 or at only particular portions of surface 104. As an example and not by way of limitation, surface 104 may include certain portions that detect proximity and/or touch, and different portions that detect gestures. In particular embodiments, surface 104 may detect a gesture (or a change in a gesture) without the user having to actually touch surface 104.

Surface 104 may further detect when a user actually touches surface 104. As an example and not by way of limitation, when a user moves his finger (or any other object) to touch a particular portion of surface 104, surface 104 may detect the motion of the user's finger, the location of the user's finger during the touch, and also the actual touching of the particular portion by the user's finger. Surface 104 may detect a touch in any suitable manner. As an example and not by way of limitation, surface 104 may include one or more touch sensors for detecting the proximity of a user's finger, and may further include one or more mechanical switches for detecting an actual touch by the user's finger. In such an example, not only may surface 104 detect the proximity of the user's fingers, but surface 104 may also provide tactile feedback to the user when the user actually touches a key of surface 104. As another example and not by way of limitation, surface 104 may include one or more touch sensors for detecting a proximity of a user's finger, and may also include one or more force sensors for detecting an actual touch by the user's finger. As a further example and not by way of limitation, surface 104 may include one or more touch sensors with different thresholds. In such an example, a first threshold of capacitive change detected by the touch sensors may indicate a proximity of the user's finger, and a second threshold of capacitive change detected by touch sensors may indicate an actual touch by the user's finger.

In addition to the detections made by surface 104, surface 104 may also communicate indications of such detections to a user device 112 through network 108. In particular embodiments, this communication may allow user device 112 to display an image representative of the user's fingers.

Network 108 represents any network operable to facilitate communication between the components of system 100, such as surface 104 and user device 112. Network 108 may include any interconnecting system capable of transmitting audio, video, signals, data, messages, or any combination of the preceding. Network 108 may include all or a portion of, a public switched telephone network (PSTN), a public or private data network, local area network (LAN), a metropolitan area network (MAN), a wide area network (WAN), a local, regional, or global communication or computer network, such as the Internet, a wireline or wireless network (such as a WI-FI network, a Bluetooth network, a cellular network), an enterprise intranet, a wired network (such as a wired (or hard wired) network that includes Universal Serial Bus (USB) cables and/or connectors (such as PS/2 connectors)), or any other communication link, including combinations thereof, operable to facilitate communication between the components.

User device 112 represents any components that display an image representative of the one or more fingers of the user on a display. Examples of user device 112 may include a smart phone, a PDA, a tablet computer, a laptop, a desktop computer, a kiosk computer, a satellite navigation device, a portable media player, a portable game console, a point-of-sale device, any device for conducting a transaction (such as an automatic teller machine (ATM)), a television, another suitable device, a suitable combination of two or more of these, or a suitable portion of one or more of these. In the illustrated embodiment, user device 112 includes a network interface 116, a processor 120, a memory 124, and a user interface 136.

Network interface 116 represents any device operable to receive information from network 108, transmit information through network 108, perform processing of information, communicate to other devices, or any combination of the preceding. As an example and not by way of limitation, network interface 116 may receive an indication of a detected proximity of one or more fingers of a user to surface 104. Network interface 116 represents any port or connection, real or virtual, including any suitable hardware and/or software, including protocol conversion and data processing capabilities, to communicate with network 108, user device 112, or other components of system 100.

Processor 120 communicatively couples to network interface 116 and memory 124, and controls the operation and administration of user device 112 by processing information received from network interface 116 and memory 124. Processor 120 includes any hardware and/or software that operates to control and process information. As an example and not by way of limitation, processor 120 executes device management application 128 to control the operation of user device 112. Processor 120 may be a programmable logic device, a microcontroller, a microprocessor, any processing device, or any combination of the preceding.

Memory 124 stores, either permanently or temporarily, data, operational software, or other information for processor 120. Memory 124 includes any one or a combination of volatile or non-volatile local or remote devices suitable for storing information. For example, memory 124 may include random access memory (RAM), read only memory (ROM), magnetic storage devices, optical storage devices, or any other information storage device or a combination of these devices. While illustrated as including particular modules, memory 124 may include any information for use in the operation of user device 112.

In the illustrated embodiment, memory 124 includes device management application 128 and surface data 132. Device management application 128 represents any suitable set of instructions, logic, or code embodied in a computer-readable storage medium and operable to facilitate the operation of user device 112.

Surface data 132 represents any information regarding the operation of surface 104 with user device 112. As an example and not by way of limitation, surface data 132 may include information that defines an image representative of surface 104 for display on user interface 136. Surface 104 may be represented as any suitable image on user interface 136 of user device 112. Examples of such representations may include a keyboard, a joystick, a piano, a mixer (such as for mixing video and/or music), any other representation of surface 104, or any suitable combination of the preceding. In particular embodiments, the image representative of surface 104 may be configurable. As an example and not by way of limitation, a user may configure the image representative of surface 104 to be any suitable image and/or have any suitable function. In such an example, a user may configure a particular portion of surface 104 to be represented as any type of key on user interface 136. Therefore, even when surface 104 is blank (or the keys on surface 104 are blank), the image representative of surface 104 may include a key with any type of icon (such as a key in any language) and having any type of function (such as a key that shuts down user device 112). As such, system 10 may provide a user with an image that is not language specific and/or not functionality specific. In particular embodiments, surface data 132 may include information that defines more than one image representative of surface 104. As an example and not by way of limitation, one image (such as a keyboard) may be representative of a first portion of surface 104, while another image (such as a joystick) may be representative of a second portion of surface 104. In such an example, each image may only be displayed when a proximity of a user's fingers is detected by the corresponding portion of surface 104. In particular embodiments, this may allow a user to view an image of a keyboard only when the user's hands are near a first portion of surface 104, and may also allow a user to view an image of a joystick only when the user's hands are near a second portion of surface 104. In particular embodiments, each of the images representative of surface 104 may be configurable to include any image and/or to correspond to any portion of surface 104.

As another example and not by way of limitation, surface data 132 may further include correlation data that correlates the image representative of surface 104 displayed on user interface 136 to surface 104. In such an example, one or more portions of the image representative of surface 104 may be correlated to one or more portions of surface 104. As such, when a user's finger is near a particular portion of surface 104, user device 112 may display an image representative of that finger near the correlated portion of the image representative of surface 104. For example and not by way of limitation, when a user's finger is near a particular portion of surface 104 (and that portion of surface 104 is correlated with the “Q” key of a keyboard image displayed on user device 112), user device 112 may display an image representative of the user's finger near the “Q” key.

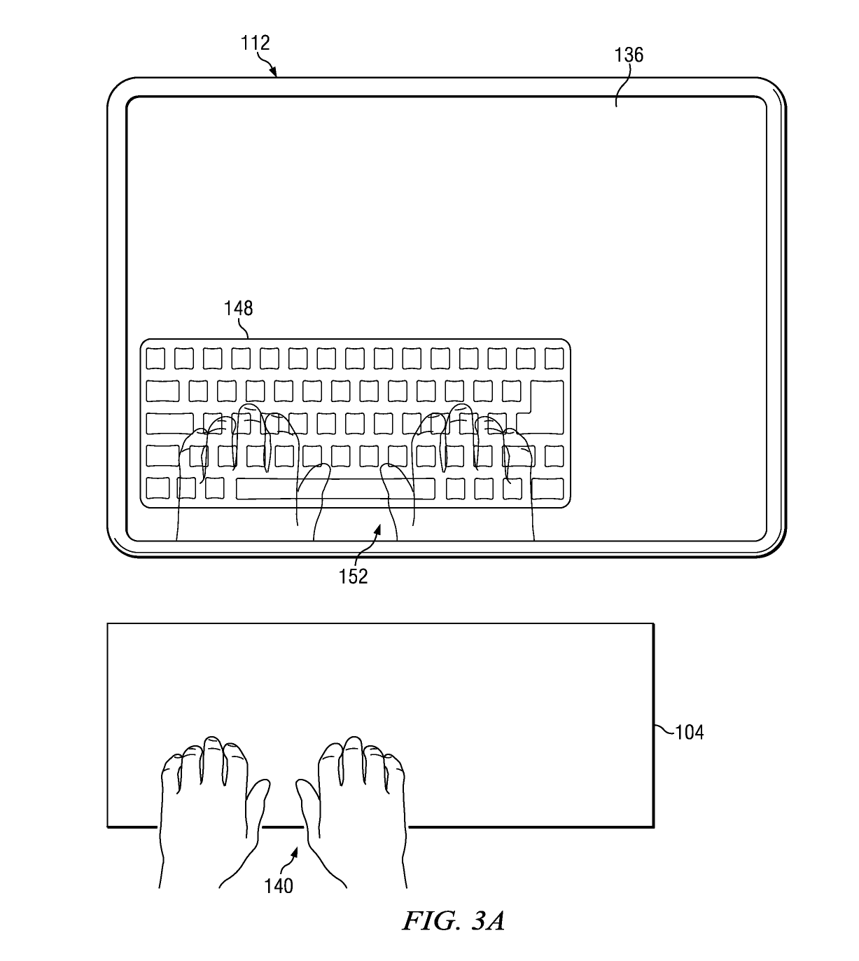

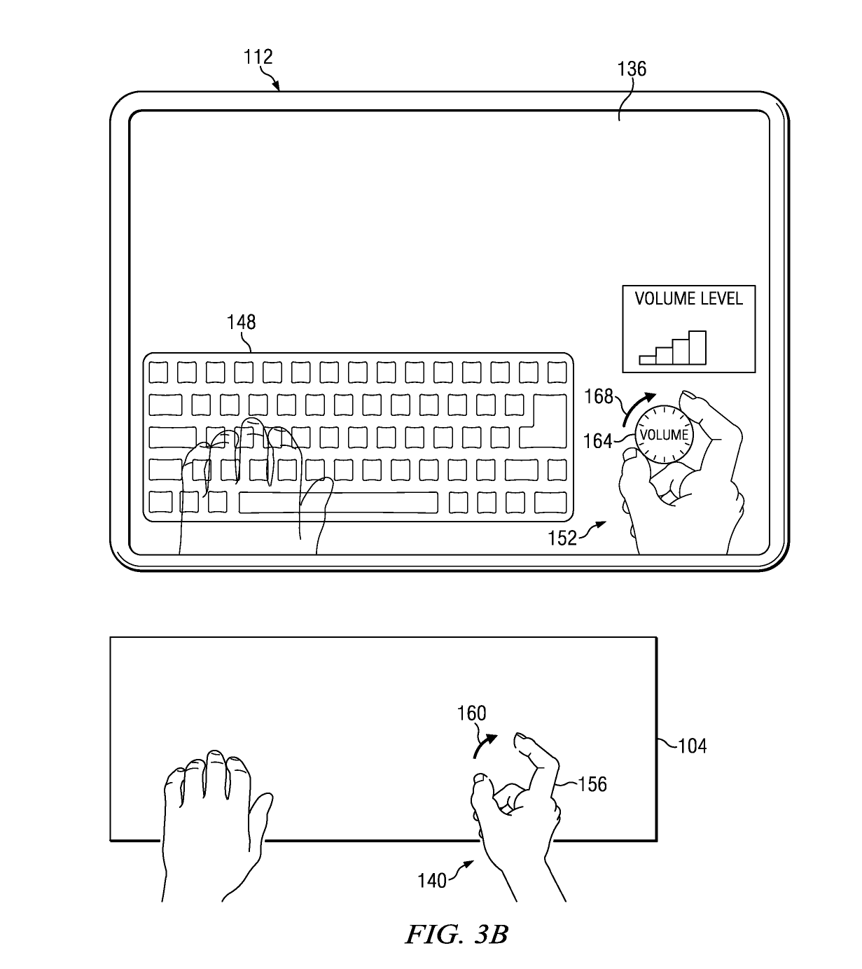

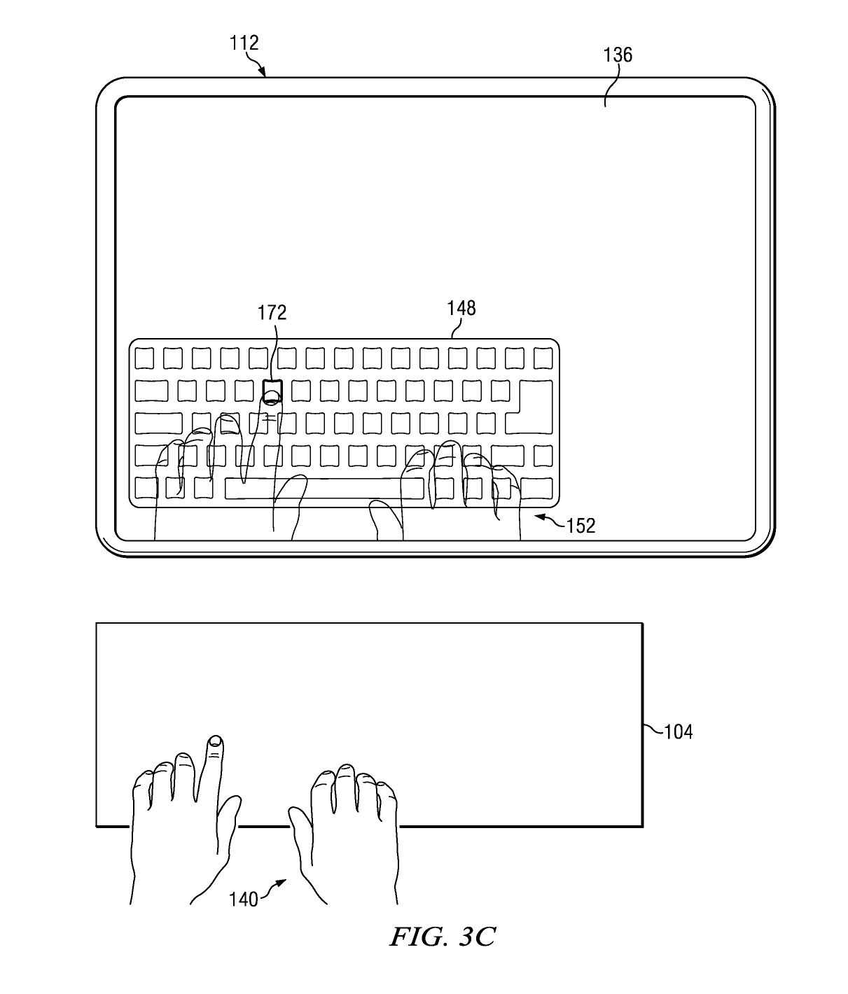

User interface 136 represents any components that display images to a user. As an example and not by way of limitation, user interface 136 may be a display screen for a desktop computer or a tablet computer. In particular embodiments, user interface 136 may display an image representative of surface 104, and may further display an image representative of the one or more fingers in correlation with at least a portion of the image representative of surface 104. Examples of the images displayed by user interface 136 are described in further detail below with regard to FIGS. 3A-3C.

Although system 100 has been described and illustrated as storing and/or executing surface data 132 in user device 112, in particular embodiments, surface data 132 (or portions of surface data 132) may be stored and/or executed by surface 104.

FIGS. 3A-3C illustrate example images displayed on user device 112. In the example of FIG. 3A, user interface 136 displays a first image 148 representative of surface 104, and further displays a second image 152 representative of one or more fingers 140.

As is discussed above, first image 148 may include any representation of surface 104. Examples of such representations may include a keyboard, a joystick, a piano, a mixer (such as for mixing video and/or music), any other representation of surface 104, or any suitable combination of the preceding. In particular embodiments, first image 148 may be configurable. In particular embodiments, first image 148 may be a ghost image that does not completely obscure another image or display underneath first image 148. Therefore, even though first image 148 is displayed over portions of another image or display, the user may still view those portions of the other image or display. In particular embodiments, first image 148 may not always be displayed on user interface 136. For example, in particular embodiments, first image 148 may only be displayed on user interface 136 when a proximity of fingers 140 is detected by surface 104. As such, any image or display beneath first image 148 may not be obscured at all by first image 148 when a user's fingers 140 are not near surface 104. As another example, in particular embodiments, first image 148 may only be displayed on user interface 136 when a particular user's biometrics are detected by surface 104. In such an example, surface 104 may include a scanner for scanning a user's biometrics. Therefore, if an unauthorized user's fingers 140 are detected by surface 104, first image 148 may not be displayed on user interface 136.

Second image 152 may include any suitable representation of fingers 140. As an example and not by way of limitation, second image 152 may include a graphical representation of fingers 140. As another example and not by way of limitation, second image 152 may include any other multi-digit interpretation of fingers 140. As a further example and not by way of limitation, a user may configure second image 152 to provide any representation of fingers 140. In such an example, a user may create and/or use various skins for second image 152. Examples of such skins may include different colors, different patterns, different proportions, different types of fingers, or any other change that may be made to second image 152. In particular embodiments, second image 152 may be a ghost image that does not completely obscure first image 148. Therefore, even though second image 152 is displayed over portions of first image 148, the user may still view those portions of first image 148.

Second image 152 is displayed on user interface 136 in correlation with first image 148. As is discussed above, a portion of first image 148 (such as a key of first image 148) may be correlated with a portion of surface 104, as is discussed above with regard to FIG. 2. Such correlation may allow user interface 136 to display second image 152 in correlation with first image 148. Therefore, when a proximity of fingers 140 is detected by surface 104, user interface, 136 may display second image 152 in the same (or approximately the same) proximity to first image 148. Furthermore, when fingers .140 move to a different location of surface 104 (thus changing the proximity), user interface 136 may display the same (or approximately the same) movement by second image 152. As an example and not by way of limitation, when fingers 140 move to the top right portion of surface 104, user interface 136 may display second image 152 moving to the top right portion of first image 148. As another example and not by way of limitation, when fingers 140 are moved in relation to each other (such as when only one finger reaches for a particular portion of surface 104) within proximity of surface 104, such a movement may be displayed by user interface 136 using second image 152. Accordingly, second image 152 may duplicate (or approximately duplicate) each movement made by fingers 140. Furthermore, second image 152 may duplicate (or approximately duplicate) the orientation of each of the fingers 140.

In the example of FIG. 3B, user interface 136 displays a third image 164 based on a gesture made by a user. According to the illustrated embodiment, surface 104 detects a gesture 156 made by fingers 140 in proximity to surface 104. A gesture may refer to any suitable action performed by a user. Examples of gestures may include a scrolling gesture (e.g., when a user moves his finger in a particular direction), a zooming gesture (e.g., when the user makes a pinching motion with two fingers to zoom out or an expanding motion with two fingers to zoom in), a turning gesture (e.g., when the user imitates like they are turning a volume knob of a device), a wake up gesture (e.g., when the user passes his hands over the surface 104 in order to wake up the user device 112), any other gestures, or any combination of the preceding.

In the illustrated embodiment, surface 104 detects fingers 140 performing a gesture 156 representative of a user turning a volume knob. In response to detection of gesture 156, user device 112 identifies the third image 164 based on gesture 156 and displays the third image 164 on user interface 136. As an example and not by way of limitation, in response to surface 104 detecting fingers 140 imitating a user turning a volume knob, device 112 may identify a volume knob image as the third image 164 and may display the volume knob as the third image 164. In particular embodiments, once the third image 164 is displayed, the user may be able to alter the third image 164. As an example and not by way of limitation, the user may perform a second gesture 160 (such as turning the volume knob clockwise or counterclockwise). Based on the detection of second gesture 160, third image 164 may be altered, as is represented by alteration 168. Therefore, when the user performs a second gesture 160 that imitates turning the volume down, user interface 136 may alter image 164 to display the volume being turned down. Furthermore, in particular embodiments, the performance of a second gesture 160 that imitates turning the volume down may also cause the user device 112 to lower the volume of sounds emitted by speakers of user device 112.

In particular embodiments, the gestures detected by surface 104 may be user configurable. As an example and not by way of limitation, a user may perform a particular gesture within proximity of surface 104, and then the user may then indicate on user device 112 what that gesture represents. As an example and not by way of limitation, the user may move fingers 140 in front of surface 104 in a scrubbing motion, and then indicate that this scrubbing motion gesture should represent erasing portions of images displayed on user interface 136. Therefore, by performing such a gesture, a user may be able to erase an image displayed on user interface 136.

In the example of FIG. 3C, user interface 136 displays an image of a user touching the surface 104. According to the illustrated embodiment, a user may cause one of fingers 140 to touch (or contact) a portion of surface 104. In response to surface 104 detecting such a touch, user interface 136 alters first image 148 to display the touch, such as by altering portion 172 of first image 148. As an example and not by way of limitation, when a user touches a portion of surface 104 that is correlated with a “Q” key of first image 148, user interface 136 may alter second image 148 to indicate that the “Q” key has been touched. First image 148 may be altered in any manner in order to indicate the touch. Examples of such indications may include displaying portion 172 as being depressed (such as by lowering the level of portion 172 in relation to the rest of first image 148), changing the color of portion 172, highlighting and/or outlining portion 172, any other suitable indication, or any combination of the preceding. In addition to altering first image 148, the movement of fingers 140 towards the touched portion of surface 104 may also be displayed on user interface 136. As an example and not by way of limitation, user interface 136 may both alter first image 148 to indicate the touch, and may also alter second image 152 to indicate one of the fingers 140 reaching out to touch that particular portion of surface 104. As such, user interface 136 may display an accurate (or approximate) representation of the user reaching out to touch a portion of surface 104.

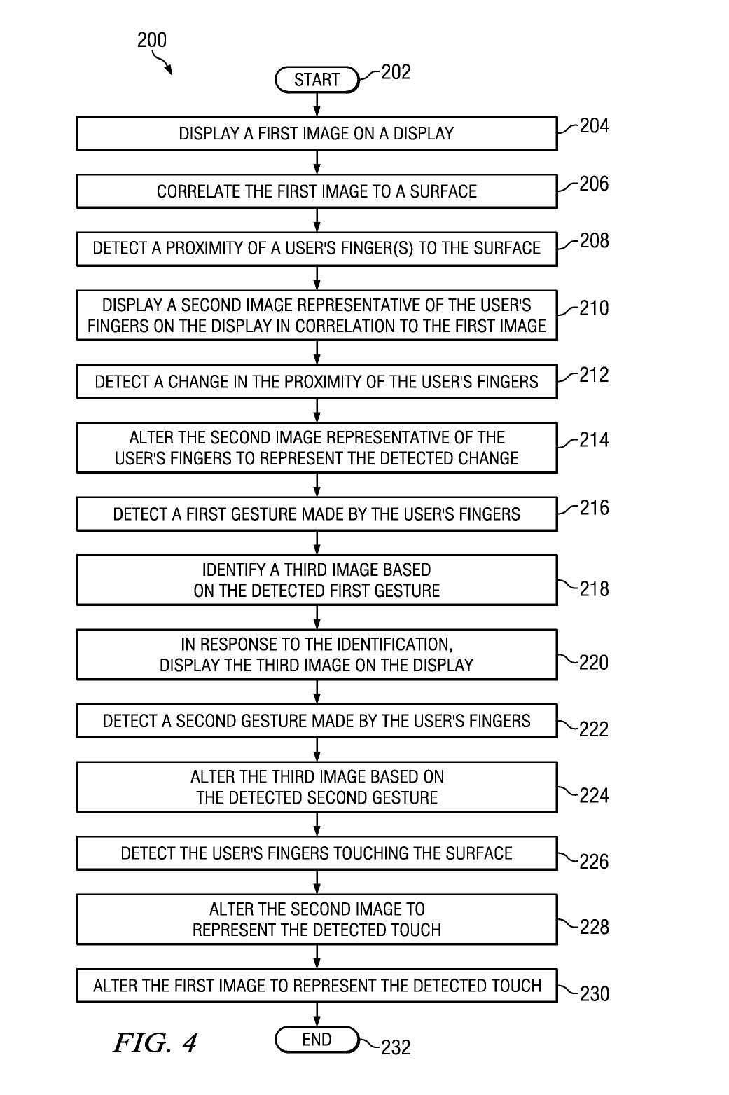

FIG. 4 illustrates an example method 200 for detecting a proximity of one or more fingers of a user to a surface and displaying an image representative of the one or more fingers on a display. One or more of the steps (or portions of the steps) of method 200 may be performed by user device 112, keyboard 104, or any other suitable components.

The method begins at step 202. At step 204, a first image is displayed on a display. In particular embodiments, the first image may be representative of surface 104. As an example, and not by way of limitation, the first image may be a keyboard representation of surface 104. In particular embodiments, the first image may be displayed on the display prior to a proximity of a user's finger(s) (or any other object) to the surface being detected. In particular embodiments, the first image may not be displayed on the display until a proximity of a user's finger(s) (or any other object) to the surface has been detected. In particular embodiments, the first image may not be displayed on the display until a particular user's biometrics are detected. In particular embodiments, the first image may also be prevented from displaying by one or more applications and/or software being executed by a processor. For example, if a programmer does not want a display of an application to be obscured in any way by the first image, one or more instructions in the application may prevent the first image (and the second image) from being displayed while the application is being executed.

At step 206, the first image is correlated to a surface. In particular embodiments, at least a portion of the first image is correlated to at least a portion of the surface. As an example and not by way of limitation, the top left portion of the first image may be correlated to the top left portion of surface 104. As another example and not by way of limitation, when first image is a keyboard, a particular key of the first image (such as the “Q” key of the keyboard) may be correlated to a particular portion of surface 104.

At step 208, a proximity of a user's finger(s) (or any other object) to the surface is detected. As an example and not by way of limitation, when the user moves one or more fingers near surface 104, the proximity of the fingers to the surface 104 may be detected by the touch sensors of surface 104. In particular embodiments, the proximity of the user's fingers may be detected without the user touching the surface.

At step 210, a second image representative of the user's fingers is displayed on the display in correlation to the first image. In particular embodiments, a second image representative of the one or more fingers is displayed on the display in correlation with the at least a portion of the first image. As an example and not by way of limitation, when the surface 104 detects the user's fingers near the top left portion of surface 104 (and an indication of this detection is communicated to user device 112), the second image representative of the user's fingers may be displayed near the top left portion of the first image representative of the surface 104. The second image representative of the user's fingers may include any suitable image. As an example and not by way of limitation, the second image may include a graphical representation of the user's fingers. As another example and not by way of limitation, the second image may include any other multi-digit interpretation of the user's fingers, such as cursers and/or pointers. As a further example and not by way of limitation, a user may configure the second image to provide any representation of the user's fingers. In particular embodiments, the second image may be a ghost image that does not completely obscure the first image.

At step 212, a change in the proximity of the user's fingers is detected. As an example and not by way of limitation, when the user's fingers move from the top left portion of the surface 104 to the top right portion of the surface 104, the change in proximity is detected. As another example and not by way of limitation, when the user moves a single finger from a first portion of the surface 104 to a second portion of the surface 104 (such as when the finger reaches out towards the second portion), the change in the proximity is detected. In particular embodiments, the change in proximity of the user's fingers may be detected without the user touching the surface.

At step 214, the second image representative of the one or more fingers is altered to represent the detected change. As an example and not by way of limitation, when the surface 104 detects the user's fingers moving from the top left portion of the surface 104 to the top right portion of the surface 104 (and an indication of this detection is communicated to user device 112), the second image may be altered to represent the movement of the user's fingers moving from the top left portion of the first image to the top right portion of the first image. As another example and not by way of limitation, when the surface 104 detects only a single finger moving from the first portion of the surface 104 to a second portion of the surface 104 (such as when the finger reaches out towards the second portion), the second image may be altered to represent the movement of the single finger. As a further example and not by way of limitation, when the surface 104 detects the user's fingers moving closer to or farther away from a portion of the surface 104, the second image may be altered to represent the one or more fingers moving closer to or farther away from a portion of the first image. Accordingly, the second image may be altered to duplicate (or approximately duplicate) each movement made by the user's fingers.

At step 216, a first gesture made by user's fingers is detected. As an example and not by way of limitation, surface 104 may detect the user using his fingers to imitate turning a volume knob. In particular embodiments, the first gesture may be detected without the user touching the surface.

At step 218, a third image is identified based on the detected first gesture. As an example and not by way of limitation, based on surface 104's detection of the user using his fingers to imitate turning a volume knob, an image representative of a volume knob may be identified.

At step 220, in response to the identification, the third image is displayed on the display. As an example and not by way of limitation, in response to identifying the volume knob, the volume knob may be displayed on the display.

At step 222, a second gesture made by the user's fingers is detected. As an example and not by way of limitation, surface 104 may detect the user using his fingers to imitate turning a volume knob either clockwise or counterclockwise. In particular embodiments, the second gesture may be detected without the user touching the surface.

At step 224, the third image is altered based on the detected second gesture. In particular embodiments, a portion of the third image may be altered based on the detected second gesture. As an example and not by way of limitation, based on surface 104's detection of the user using his fingers to imitate turning a volume knob either clockwise or counterclockwise, the volume knob displayed on the display may be turned clockwise or counterclockwise on the display (e.g., in order to turn the volume down or up).

At step 226, the user's fingers touching the surface is detected. As an example and not by way of limitation, surface 104 may detect a user's fingers moving towards a particular portion of surface 104 and touching the particular portion of surface 104.

At step 228, the second image is altered to represent the detected touch. As an example and not by way of limitation, the second image representative of the user's fingers may be altered to display the second image reaching for and touching a particular key of the first image.

At step 230, the first image is altered to represent the detected contact. In particular embodiments, a portion of the first image may be altered to represent the detected contact. As an example and not by way of limitation, when the user contacts the particular portion of surface 104, the key (which has been correlated with that particular portion of the surface 104) displayed in the first image may be altered to indicate that the key has been touched. In such an example, the key may be altered in any suitable manner. Examples of such indications may include displaying the key as being depressed (such as by lowering the level of the key in relation to the rest of the first image), changing the color of the key, highlighting and/or outlining the key, any other suitable indication, or any combination of the preceding. At step 232, the method ends.

Although method 200 has been described and illustrated in accordance with a particular embodiment, method 200 may include (or be combined with) one or more of any of the embodiments and or examples discussed above with regard to FIGS. 1-3B.

Particular embodiments may repeat the steps of the method of FIG. 4, where appropriate. Moreover, although this disclosure describes and illustrates particular steps of the method of FIG. 4 as occurring in a particular order, this disclosure contemplates any suitable steps of the method of FIG. 4 occurring in any suitable order. Additionally, one or more of the steps of the method of FIG. 4 may be performed without one or more of the other steps of the method of FIG. 4. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

Herein, reference to a computer-readable storage medium or media may include one or more semiconductor-based or other integrated circuits (ICs) (such, as for example, a field-programmable gate array (FPGA) or an application-specific IC (ASIC)), hard disk drives (HDDs), hybrid hard drives (HHDs), optical discs, optical disc drives (ODDs), magneto-optical discs, magneto-optical drives, floppy disks, floppy disk drives (FDDs), magnetic tapes, holographic storage media, solid-state drives (SSDs), RAM-drives, SECURE DIGITAL cards, SECURE DIGITAL drives, or any other suitable computer-readable storage medium or media, or any suitable combination of two or more of these, where appropriate. A computer-readable non-transitory storage medium may be volatile, non-volatile, or a combination of volatile and non-volatile, where appropriate.

Herein, reference to a computer-readable non-transitory storage medium or media may include one or more semiconductor-based or other integrated circuits (ICs) (such, as for example, a field-programmable gate array (FPGA) or an application-specific IC (ASIC)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards, SECURE DIGITAL drives, any other suitable computer-readable non-transitory storage medium or media, or any suitable combination of two or more of these, where appropriate. A computer-readable non-transitory storage medium or media may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
displaying a first image on a display;
correlating at least a portion of the first image to at least a portion of a surface, the surface including one or more sensors operable to detect a proximity of one or more fingers of a user to the surface;
detecting the proximity of the one or more fingers of the user to the surface, the proximity of the one or more fingers being detected without the one or more fingers touching the surface; and
displaying a second image representative of the one or more fingers on the display in correlation with the at least a portion of the first image.

2. The method of claim 1, further comprising:
detecting, without the one or more fingers touching the surface, a change in the proximity of the one or more fingers to the surface; and
altering the second image to represent the detected change.

3. The method of claim 1, further comprising:
detecting, without the one or more fingers touching the surface, the one or more fingers moving closer to or farther away from the at least a portion of the surface; and
altering the second image to represent the one or more fingers moving closer to or farther away from the at least a portion of the first image.

4. The method of claim 1, wherein the first image comprises a keyboard.

5. The method of claim 4, further comprising:
correlating the at least one key of the keyboard to the at least a portion of the surface; and
displaying the second image on the display in correlation with the at least one key.

6. The method of claim 1, further comprising:
detecting, without the one or more fingers touching the surface, a first gesture made by the one or more fingers;
identifying a third image based on the detected first gesture; and
in response to the identification, displaying the third image on the display.

7. The method of claim 6, further comprising:
detecting, without the one or more fingers touching the surface, a second gesture made by the one or more fingers; and
altering at least a portion of the third image based on the detected second gesture.

8. The method of claim 1, further comprising:
detecting the one or more fingers touching the at least a portion of the surface;
altering the second image to represent the detected touch; and
altering the at least a portion of the first image to represent the detected touch.

9. One or more computer-readable non-transitory storage media embodying logic that is configured when executed to:
generate, for display, a first image;
correlate at least a portion of the first image to at least a portion of a surface that includes one or more sensors operable to detect a proximity of one or more fingers of a user to the surface;
receive an indication of the detected proximity of the one or more fingers of the user to the surface, the proximity of the one or more fingers being detected without the one or more fingers touching the surface; and
generate, for display, a second image representative of the one or more fingers in correlation with the at least a portion of the first image.

10. The media of claim 9, wherein the logic is further configured when executed to:
receive an indication of a detected change in the proximity of the one or more fingers to the surface, the change in the proximity of the one or more fingers being detected without the one or more fingers touching the surface; and
generate, for display, an alteration of the second image to represent the detected change.

11. The media of claim 9, wherein the logic is further configured when executed to:
receive an indication of a detection of the one or more fingers moving closer to or farther away from the at least a portion of the surface, the movement of the one or more fingers closer to or farther away from the at least a portion of the surface being detected without the one or more fingers touching the surface; and
generate, for display, an alteration of the second image to represent the one or more fingers moving closer to or farther away from the at least a portion of the first image.

12. The media of claim 9, wherein the logic is further configured when executed to:
receive an indication of a detected first gesture made by the one or more fingers, the first gesture being detected without the one or more fingers touching the surface;
identify a third image based on the detected first gesture; and
in response to the identification, generate, for display, the third image.

13. The media of claim 12, wherein the logic is further configured when executed to:
receive an indication of a detected second gesture made by the one or more fingers, the second gesture being detected without the one or more fingers touching the surface; and
generate, for display, an alteration of at least a portion of the third image based on the detected second gesture.

14. The media of claim 9, wherein the logic is further configured when executed to:
receive an indication of a detection of the one or more fingers touching the at least a portion of the surface;
generate, for display, an alteration of the second image to represent the detected touch; and
generate, for display, an alteration of the at least a portion of the first image to represent the detected touch.

15. A system, comprising:
a surface comprising one or more sensors operable to detect a proximity of one or more fingers of a user to the surface, the proximity of the one or more fingers being detected without the one or more fingers touching the surface; and
one or more processors operable to:
generate, for display, a first image;
correlate at least a portion of the first image to at least a portion of the surface;
receive an indication of the detected proximity of the one or more fingers; and
generate, for display, a second image representative of the one or more fingers in correlation with the at least a portion of the first image.

16. The system of claim 15, wherein the one or more processors are further operable to:
receive an indication of a detected change in the proximity of the one or more fingers to the surface, the change in the proximity of the one or more fingers being detected without the one or more fingers touching the surface; and
generate, for display, an alteration of the second image to represent the detected change.

17. The system of claim 15, wherein the one or more processors are further operable to:
receive an indication of a detection of the one or more fingers moving closer to or farther away from the at least a portion of the surface, the movement of the one or more fingers closer to or farther away from the at least a portion of the surface being detected without the one or more fingers touching the surface; and
generate, for display, an alteration of the second image to represent the one or more fingers moving closer to or farther away from the at least a portion of the first image.

18. The system of claim 15, wherein the one or more processors are further operable to:
receive an indication of a detected first gesture made by the one or more fingers, the first gesture being detected without the one or more fingers touching the surface;
identify a third image based on the detected first gesture; and
in response to the identification, generate, for display, the third image.

19. The system of claim 18, wherein the one or more processors are further operable to:
receive an indication of a detected second gesture made by the one or more fingers, the second gesture being detected without the one or more fingers touching the surface; and
generate, for display, an alteration of at least a portion of the third image based on the detected second gesture.

20. The system of claim 15, wherein the one or more processors are further operable to:
receive an indication of a detection of the one or more fingers touching the at least a portion of the surface;
generate, for display, an alteration of the second image to represent the detected touch; and
generate, for display, an alteration of the at least a portion of the first image to represent the detected touch.
